(19) United States
(12) Patent Application Publication
(10) Pub. No.: US 2019/0274315 A1
(43) Pub. Date: Sep. 12, 2019

(54) Toaster Oven With Conveyor

(71) Applicant: RJ Brands LLC, Mahwah, NJ (US)

(72) Inventors: Ralph Newhouse, Monsey, NY (US); Deomedes Alimorong Apilado, Pingshan (CN)

(73) Assignee: RJ Brands LLC, Mahwah, NJ (US)

(21) Appl. No.: 16/294,722

(22) Filed: Mar. 6, 2019

Related U.S. Application Data
(60) Provisional application No. 62/639,815, filed on Mar. 7, 2018.

(51) Int. Cl. A21B 1/48; A21B 1/26

(52) U.S. Cl. CPC A21B 1/48; A21B 1/26

(57) ABSTRACT

A toaster oven which incorporates a conveyor system to more efficiently cook foodstuffs in a more convenient and enjoyable manner. The toaster oven offers a viewing window for users to ensure the conveyed items are cooking to their desired degree. The conveyor cartridge is insertable and removable into and from the toaster oven housing, and allows users to install and remove the conveyor belt. The toaster oven may have at least one door which is rotatably attached to the toaster oven housing and allows users to open or close said door to a range of degrees. The toaster oven may have a first door providing the entry point of food products into the body and a second door providing the exit point of food products from within the body of said toaster oven. The toaster oven may have a front loading door pivotably attached to the toaster oven housing and having the ability to open and close. The control panel on the toaster oven allows users to select their desired cooking options and choose the speed of rotation of the conveyor belt.

### BACKGROUND OF THE INVENTION

This invention relates to toasters and more particularly to household toasters having conveyors which carry food products through a heated cavity at a rate and temperature controlled by users to produce a food product cooked to a desired degree.

### SUMMARY OF THE INVENTION

The present invention is an improvement over the typical convection toaster oven with one or more doors and conveyor technology. The present invention incorporates a conveyor system to more efficiently cook foodstuffs in a more convenient and enjoyable manner. The toaster oven offers a viewing window for users to ensure the conveyed items are cooking to their desired degree. The conveyor cartridge is insertable and removable into and from the toaster oven housing, and allows users to install and remove the conveyor belt. The toaster oven may have at least one door which is rotatably attached to the toaster oven housing and allows users to open or close said door to a range of degrees. The toaster oven may have a first door providing the entry point of food products into the body of the toaster oven, and a second door providing the exit point of food products. The toaster oven may have a front loading door pivotably attached to the toaster oven housing and having the ability to open and close. The control panel on the toaster oven allows users to select their desired cooking options and choose the speed of rotation of the conveyor belt.

In one embodiment, the control panel of the present invention provides a touch screen interface for users to select their desired cooking options. In one embodiment, the present invention operates remotely by the use of an application on a smart device. In one embodiment, the present invention is configured to follow instructions transmitted to it via guided cooking options displayed to users on a mobile app or preprogramed within the control panel.

### BRIEF DESCRIPTION OF THE SEVERAL VIEWS OF THE DRAWINGS

Some embodiments of the present invention are illustrated as an example and are not limited by the figures of the accompanying drawings, in which like references may indicate similar elements and in which:

FIG. 1 illustrates a top perspective view of a toaster oven with conveyor with closed exist door, in accordance with one or more embodiments of the present disclosure;

FIG. 2 illustrates a top perspective view of a toaster oven with conveyor with closed entry door, in accordance with one or more embodiments of the present disclosure;

FIG. 3 illustrates a top perspective view of a toaster oven with conveyor with open entry and exit door, in accordance with one or more embodiments of the present disclosure;

FIG. 4 a front view of a toaster oven with conveyor on removable of conveyor with open entry and exit door, in accordance with one or more embodiments of the present disclosure; and

FIG. 5 illustrates a sectional view of a toaster oven with conveyor with open entry and exit door, in accordance with one or more embodiments of the present disclosure;

### DETAILED DESCRIPTION OF THE INVENTION

The present disclosure is to be considered as an exemplification of the invention, and is not intended to limit the invention to the specific embodiments illustrated by the figures or description below.

The terminology used herein is for the purpose of describing particular embodiments only and is not intended to be limiting of the invention. As used herein, the term “and/or” includes any and all combinations of one of more of the associated listed items. It will further be understood that the terms“comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs.

Disclosed herein is a toaster oven primarily consisting of:

a housing having components disposed in an interior of said housing;

rotatable shafts operatively associated with anelectric drive motor driven by an electric source;

at least one conveyor belt trained over said rotatable shafts; and

a heating means for heating conveyed food products.

In one embodiment, the conveyor belt rotatable shafts are configured with gears that operatively rotate said conveyer belt. Gears are known in the art to be toothed or untoothed circular members such as sprockets, able to engage and rotate with conveyor belts.

In one embodiment, the conveyor toaster has a first door providing the initial point of placement of said food products into the body of said conveyor toaster and a second door providing the point of exit of food products from within the body of said conveyor toaster.

In one embodiment, the conveyor toaster has digital control means for selecting customizable cooking options such as temperature, time, toast presets, conveyor speed, or combinations thereof; and an electronic interface between said digital control means and said drive motor providing adjustment to rotation speed based on said selecting customizable cooking options of said drive motor and ultimately movement of said main conveyor belt. In one embodiment, said electronic interface additional allows users to place the conveyor belt in “static mode,” wherein the conveyor belt does not move or rotate and the food is cooked in a static position.

In one embodiment, the heating means is an infrared lamp. In one embodiment, the heating means is primarily made of tungsten metal. In one embodiment, the heating means is primarily made of nichrome. In one embodiment, the heating means is a halogen heating source. In one embodiment, the heating means is a combination of multiple heating elements; which may consist of one halogen heating source, two infrared lamps on the top of, and two infrared lamps on the bottom of the toaster oven interior region.

In one embodiment, the toaster oven has a transparent viewing panel for viewing food products as they proceed through the toaster oven on said conveyor belt to allow users to view the food stuffs being conveyed through the toaster while maintaining the heat in the oven cavity.

In one embodiment, the conveyor belt frame fits into the inner body of the toaster oven and is insertable and removable into and from the toaster oven providing for easy installation, removal, and replacement of said conveyor belt from within said toaster oven. In some embodiments, the conveyor belt is constructed within a conveyor cartridge to facilitate the ability of a user to insert and remove the conveyor belt and easily install, remove, or replace the conveyor belt from within the toaster oven housing.

In one embodiment, the conveyor cartridge utilizes a clutch mechanism to allow for the ejection or installation of the conveyor belt from or into the toaster oven. In this embodiment, the rotatable shafts are composed of two shaft components: the drive shaft and the guide shaft. The clutch mechanism utilized in this embodiment is a novel spring loaded clutch system in which a female clutch, located on one end of a rotatable shaft, is forced to come into contact with a male clutch, located on the drive motor, by a spring which is compressed between the drive shaft and guide shaft end of the rotatable shaft. This clutch mechanism allows a user to disengage the conveyor belt from the toaster oven by gripping and sliding a drive sprocket frontward, overcoming the force exerted by the spring inside the rotatable shaft, thereby releasing the female clutch from the male clutch. When the clutches are disengaged, the user is able to pull out the conveyor cartridge.

To install the conveyor belt into the toaster, a user simply pushes the conveyor cartridge inside the oven. Once the conveyor cartridge is pushed inside the oven, a lever approaching the chassis is triggered to push in the female clutch of the conveyor drive so that the conveyor cartridge can be fully inserted. When the lever approaches the conveyor belt slot, the female clutch located on the rotatable shaft retracts to engage with the male clutch located on the drive motor. In one embodiment, the second door is pivotably attached to the conveyor cartridge. In this embodiment, the conveyor cartridge and the second door are both removable from the toaster oven. When the toaster oven is configured in this way, a user is able to pull out the second door and the chain link conveyor belt by pulling the second door. This creates a wider opening and enables a user to easily clean the toaster oven chamber.

In one embodiment, the second door is not attached to the conveyor cartridge, rather, its pivot axis can be detached from the body of the toaster. In this embodiment, the second door is permanently pivotably connected to second door flap which allows the second door to extend outward when its pivot axis is de-tached from the toaster oven housing, all the while remaining pivotably attached to the second door flap. Therefore, in this embodiment, the chamber opening is wider than the opening is when the second door pivot access is attached, and a user can easily reach into the toaster oven body and remove the conveyor belt via the conveyor cartridge from within the toaster oven body. When the second door is detached, and the conveyor belt is removed from within the body of the toaster oven, a user is able to easily clean and maintain the inside of the toaster oven.

In one embodiment, the first door comprises an open-closing latch for opening and closing said first door and the second door similarly comprises an open-closing latch for opening and closing said second door.

In one embodiment, the invention further comprises a first door which permits rotation about said connection's axis and allows for control of the extent to which the door is to be opened. That is to say a user can position the door to be fully open, half open, partially open, or any desired degree of open. In one embodiment, the first door includes structures to fix the door into a position reflecting a desired degree of opening.

In one embodiment, the invention further comprises a second door which permits rotation about said connection's axis and allows for control of the extent to which the door is to be opened. That is to say a user can position the door to be fully open, half open, partially open, or any desired degree of open. In one embodiment, the second door includes structures to fix the door into a position reflecting a desired degree of opening. In one embodiment, the second door can be unhinged from the connection axis, enabling the door to extend to a fully open position in order to allow users to clean and maintain the toaster.

In one embodiment, the first and second insulated doors are composed of two layers of an insulating material constructed to maintain the heat created within said toaster oven.

In one embodiment, the toaster oven has a front loading door pivotably attached to the toaster oven housing and having the ability to open and close.

In one embodiment, the toaster oven has a control pad as a user interface. In some embodiments, this control pad is a touch screen interface well known in the art for allowing users to select the toaster control operations. In some embodiments, the toaster has the ability to be operated remotely using a method well known in art wherein users utilize an application on their smart device to operate the toaster remotely.

In one embodiment, the toaster oven is configured to follow instructions transmitted to it via “guided cooking” options displayed to users on materials such as a mobile app, where users are given step by step cooking instructions needed to create their desired foods.

The present invention will now be described by referencing the appended figures representing preferred embodiments.

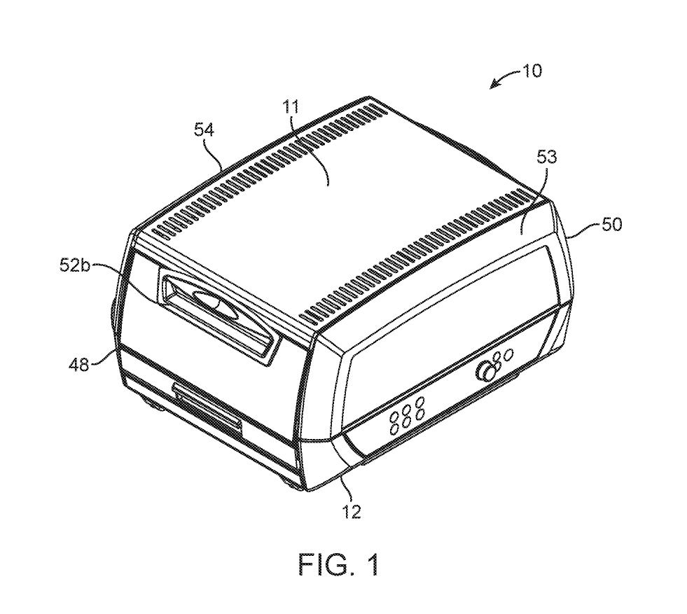

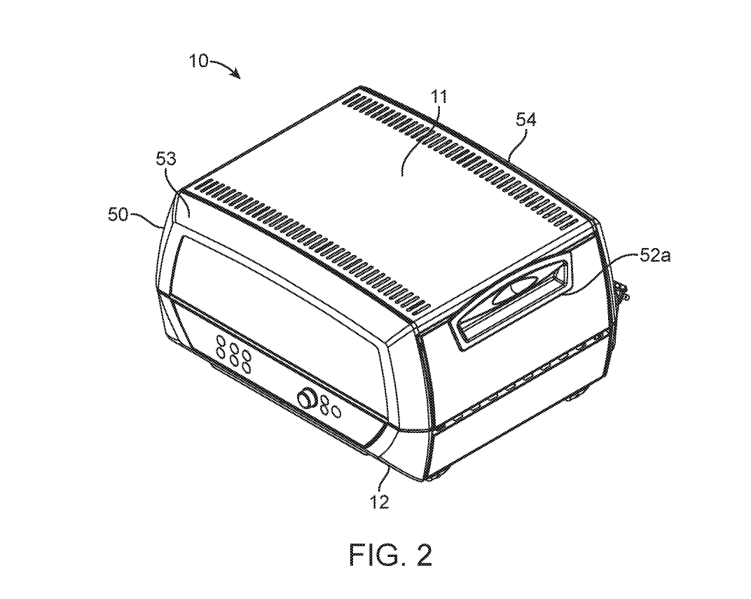

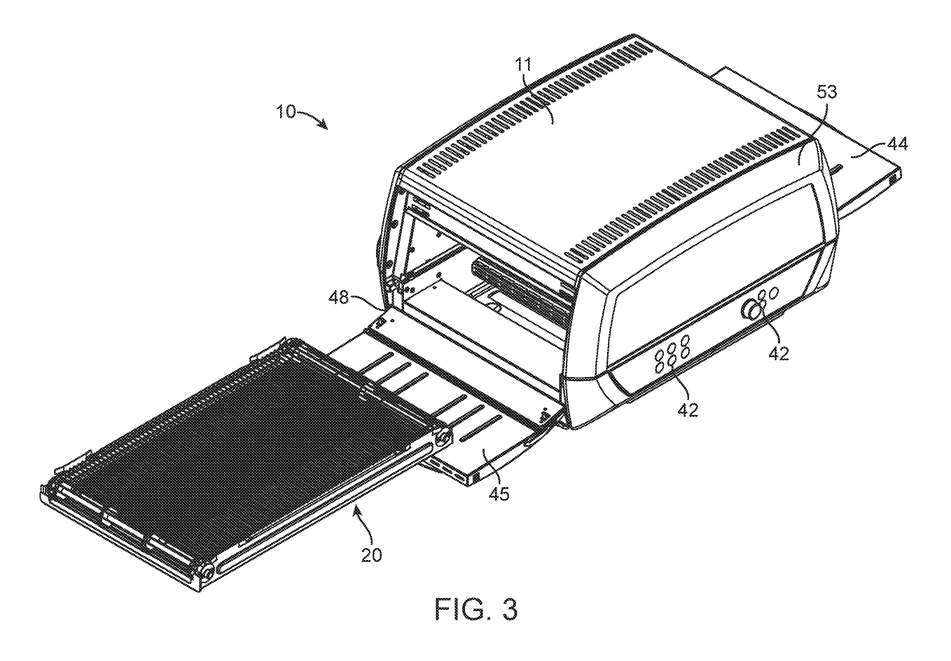

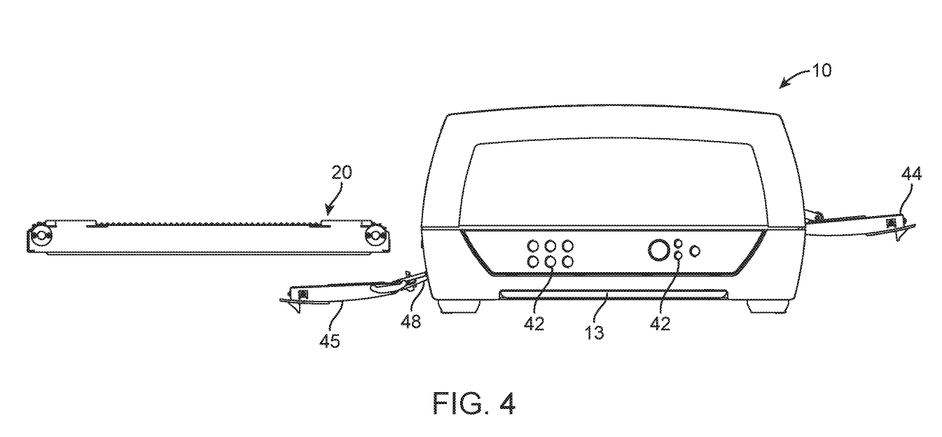

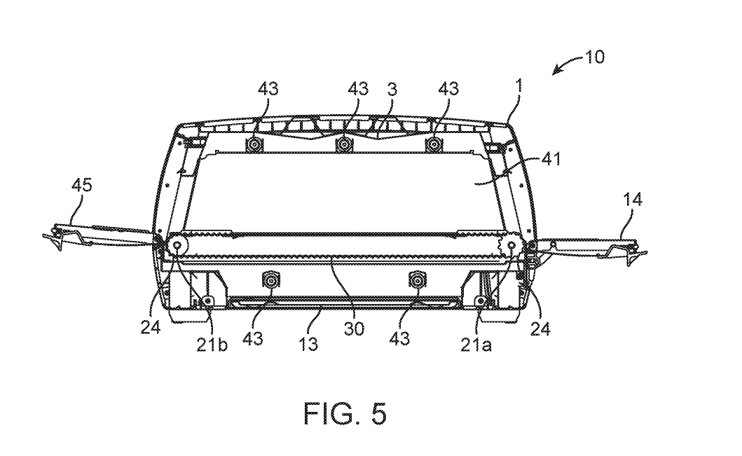

Referring now to FIGS. 1-5, there is generally depicted a toaster oven 10 according to a preferred embodiment of the present invention.

In one non-limiting example, toaster oven 10 includes a toaster oven housing 50, having an interior region 41 in which components are positioned. Interior region 41 generally comprises a chassis 1; a ceiling 3; an upper guard; a lower guard; a conveyor belt 30; trained over two rotatable shafts 21a, 21b; a heating means 43 for heating or cooking food products; a crumb tray 13; a first door 44 providing the initial point of placement of said food products into interior region 41 of said conveyor toaster; and a second door 45 providing the point of exit of food products from within interior region 41 of said conveyor toaster.

In one embodiment, toaster oven housing 50 is composed of housing top 11, housing bottom 12, housing front 53, and housing back 54. In some embodiments, housing top 11 is porous, allowing for air ventilation.

In one embodiment, conveyor belt 30 is trained over rotatable shaft 21a at a first end and over rotatable shaft 21b at a second end. Rotatable shafts 21a and 21b are generally aligned and maintained at a distance from one another.

In one embodiment, conveyor belt 30 is housed within a conveyor cartridge 20 composed of a conveyor frame front and a conveyor frame back. Conveyor cartridge 20 fits into toaster oven interior region 41. In some embodiments, conveyor cartridge 20 is insertable and removable, providing for easy installation, removal, and replacement of conveyor belt 30 from within toaster oven interior region 41.

In one embodiment, conveyor cartridge 20 utilizes rotatable shafts 21a and 21b, where rotatable shaft 21a is operatively associated with electric drive motor, known in the art to perform a rotational operation when powered by an electric source. In this embodiment, rotatable shafts 21a and 21b have toothed gears 24 which engage conveyor belt 30, and lead the conveyor belt 30 to rotate about rotatable shafts 21a and 21b along the toothed gears 24. When rotatable shaft 21a is engaged by drive motor, gears 24 on rotatable shaft 21a cause conveyor belt 30 to begin rotating. When conveyor belt 30 is engaged in this way and begins rotating, conveyor belt 30 is simultaneously engaged with gears 24 on rotatable shaft 21b, which rotates along with rotatable shaft 21a as a result.

In one embodiment, conveyor cartridge 20 utilizes a spring clutch mechanism to allow for the ejection or installation of conveyor cartridge 20 from or into toaster oven interior region 41. In this embodiment, rotatable shaft 21a is composed of two shaft components: drive shaft and guide shaft. The spring clutch mechanism utilized in this embodiment is a novel spring loaded clutch system in which female clutch, located on one end of rotatable shaft 21a, is forced to come into contact with male clutch, located on drive motor, by spring, which is compressed between drive shaft and guide shaft of rotatable shaft 21a. This clutch mechanism allows a user to dis-engage conveyor cartridge 20 from within toaster oven 10 by gripping and sliding drive sprocket 24 frontward, overcoming the force exerted by spring inside rotatable shaft 21a, thereby releasing female clutch from male clutch. When clutches are disengaged, the user is able to pull out conveyor cartridge 20 from within toaster oven 10.

To install conveyor cartridge 20 into the toaster, a user simply pushes conveyor cartridge 20 into toaster oven 10 interior region 41. Once conveyor cartridge 20 is pushed inside the toaster oven 10, lever, approaching chassis 1, is triggered to push in female clutch so that conveyor cartridge 20 can be fully inserted. When lever approaches conveyor belt slot, female clutch retracts to engage with male clutch.

First door 44 is the door used for food entry. First door 44 can be placed in a closed, inclined, or horizontal staging position. First door 44 additionally has a fail safe position in which it overturns in case of overloading to prevent damage. Second door 45 is the door used for food exiting toaster oven 10. Similarly to first door 44, second door 45 can be placed in a closed, inclined, or horizontal staging position. Second door 45 also has a fail safe position in which it overturns in case of overloading to prevent damage.

In one embodiment, first and second doors 44 and 45 are insulated to optimize the cooking process. To accomplish insulation of the doors, first door 44 is composed of inner door portion and outer door portion and second door 45 is composed of inner door portion and outer door portion.

In one embodiment, first door 44 is pivotably attached to conveyor cartridge 20. In some embodiments, first door 44 is attached to conveyor cartridge 20 by hinge. First door 44 generally permits rotation about the connection between first door 44 and toaster oven housing 50 and allows a user to control the extent of opening first door 44. That is to say a user can position first door 44 to be fully open, half open, partially open, or any desired degree of open. In one embodiment, first door 44 includes structures to fix the door into a position reflecting a desired degree of opening.

In one embodiment, second door 45 is pivotably attached to conveyor cartridge 20. In some embodiments, second door 45 is attached to conveyor cartridge 20 by hinge. Second door 45 generally permits rotation about the connection between first door 44 and toaster oven housing 50 and allows a user to control the extent of opening second door 45. That is to say a user can position second door 45 to be fully open, half open, partially open, or any desired degree of open. In one embodiment, second door 45 includes structures to fix the door into a position reflecting a desired degree of opening.

In one embodiment, second door 45 is pivotably attached to conveyor cartridge 20. In this embodiment, conveyor cartridge 20 and second door 45 are both removable from toaster oven interior region 41. When toaster oven 10 is configured in this way, a user is able to pull out second door 45 and conveyor belt 30 by pulling out second door 45. This creates a wider opening and enables a user to easily clean the toaster oven interior region 41.

In one embodiment, second door 45 is detachable from toaster oven housing 50 at its pivot axis 48. In this embodiment, second door 45 is permanently pivotably connected to second door flap. Further in this embodiment, second door 45 extends outward when pivot axis 48 is detached from toaster oven housing 50, but remains pivotably attached to second door flap. When second door 45 is extended outward in this way, toaster chamber opening is wider than the opening is when second door pivot axis 48 is attached, and a user can easily reach into the toaster oven interior region 41 and remove conveyor belt 30 via conveyor cartridge 20. When second door 45 is detached, and conveyor belt 30 is removed from within toaster oven interior region 41, a user is able to easily clean and maintain the inside of the toaster oven.

In one embodiment, first door 44 comprises an open-closing latch 52a for opening and closing first door 44, and second door 45 comprises an open-closing latch 52b for opening and closing second door 45.

In one embodiment, heating means 43 is located either on the top, bottom, or both of the toaster oven interior region 41, known to those skilled in the art as a source of heat such as infrared, tungsten, nichrome, or halogen materials that are placed within the toaster oven to evenly and efficiently cook food products. In one embodiment, heater means 43 is an infrared lamp. In one embodiment heater means 43 is primarily made of tungsten metal. In another embodiment, heater means 43 is primarily made of nichrome. In one embodiment, the heating means 43 is a halogen heating source. In one embodiment, heating means 43 is generally held in place by lower rear holder, lower front left holder, and lower front right holder. In one embodiment, the heating means 43 is a combination of multiple heating elements; which may consist of one halogen heating source, two infrared lamps on the top of, and two infrared lamps on the bottom of the toaster oven interior region 41.

In one embodiment, housing front 53 includes control panel 42. Control panel 42 may include a start/stop button; a timer button to select cook time; a temperature button to select cook temperature; a temperature/cook time display; up/down buttons to control temperature and cook time; a toast preset button; a toast shade display; arrow buttons to select toast shade; a reheat button to preset conveyor speed, time, and temperature; a conveyor speed display; conveyor speed selection buttons; and an eject button. The toaster's temperature is controlled by pressing the temperature button and subsequently pressing the up/down buttons to increase or decrease the preset temperature displayed on the temperature/cook time display, thus increasing or decreasing the temperature within the toaster. The toaster's cook time is similarly controlled by pressing the timer button and subsequently pressing the up/down buttons to increase or decrease the cook time displayed on the temperature/cook time display, thus increasing or decreasing the preset cook time displayed on the temperature/cook time display.

Although the general reference is made to cooking bread and other bread type articles, the present invention can be constructed and arranged with appropriate heat and conveyor configurations for the efficient cooking of any article. In one embodiment, conveyor belt 30 is configured to move at variable speed congruent with user selected time and or temperature functions. In this configuration, the user does not need to be concerned with the overcooking or under cooking of a particularized article, as the movement through toaster oven 10 is variably dependent on a selected time and or temperature. When a user selects customizable cooking options selected from temperature, time, toast presets, conveyor speed, or combinations thereof, heater means 43 is adjusted accordingly and simultaneous with set adjustment is drive motor that will determine the rotational speed ultimately of rotatable shafts 21a and 21b, thus adjusting the speed of conveyor belt 30 in congruence with the selected customizable cooking options. In some embodiments, users are able to select a “stationary mode” in which rotatable shafts 21a and 21b remain stationary and do not rotate and conveyor belt 30 is kept in a stationary position. The ability to select between ranges of conveying modes and the stationary mode makes toaster oven 10 versatile, able to satisfy the cooking desires of a variety of users.

While the invention has been described in its preferred form or embodiment with some degree of particularity, it is understood that this description has been given only by way of example and that numerous changes in the details of construction, fabrication, and use, including the combination and arrangement of parts, may be made without departing from the spirit and scope of the invention.

What is claimed:

1. A toaster oven comprising:
A housing having an interior defining an oven cavity; said oven cavity having at least one opening;
rotatable shafts operatively associated with an electric drive motor driven by an electric source;
at least one conveyor belt trained over said rotatable shafts;
a conveyor cartridge operatively associated with said rotatable shafts within said toaster oven;
a heating means for heating said oven cavity; and
a transparent viewing panel set in said housing for viewing food products as they proceed through the toaster oven on said conveyor belt.

2. The toaster oven of claim 1 wherein said conveyor cartridge is insertable and removable into and from said toaster oven housing and allows users to install and remove said conveyor belt into and from said toaster oven.

3. The toaster oven of claim 2 wherein said conveyor cartridge is insertable and removable into and from said toaster oven housing utilizing a spring clutch mechanism.

4. The toaster oven of claim 1 wherein said conveyor belt rotatable shafts are operatively associated with gears configured operatively rotate said conveyer belt.

5. The toaster oven of claim 1 wherein said toaster oven housing includes first and second doors said first and second doors having the ability to open and close.

6. The toaster oven of claim 1 wherein said toaster oven housing includes at least one door which is rotatably attached to said housing and allow users to open or close said at least one door to a range of degrees.

7. The toaster oven of claim 1 wherein said toaster oven housing includes first and second doors which are each composed of two layers of an insulating material and constructed to maintain the temperature within said toaster oven.

8. The toaster oven of claim 1 wherein said toaster oven housing has a control panel allowing users to select their desired cooking options.

9. The toaster oven of claim 1 wherein said toaster oven housing has a control panel allowing users to choose the speed of rotation of the conveyor belt.

10. The toaster oven of claim 1 wherein the control panel provides a touch screen interface for users to select their desired cooking options.

11. The toaster oven of claim 1 wherein the toaster oven is operated remotely by the use of an application on a smart device.

12. The toaster oven of claim 1 wherein the toaster is configured to follow instructions transmitted to it via guided cooking options displayed to users on a mobile app or preprogrammed within the toaster oven control panel.

13. The toaster oven of claim 1 wherein the toaster oven is operable while first and second doors are closed.

14. A toaster oven comprising:
a housing having an interior defining an oven cavity; rotatable shafts operatively associated with an electric drive motor driven by an electric source;
at least one conveyor belt trained over said rotatable shafts;
a conveyor cartridge operatively associated with said rotatable shafts within said toaster oven;
a heating means for heating said oven cavity;
a first door providing the entry point of food products into the body of said toaster oven;
a second door providing the exit point of food products from within the body of said toaster oven; and
wherein said conveyor cartridge is insertable and removable into said toaster oven housing and allows users to install and remove said conveyor belt into and from said toaster oven.

15. The toaster oven of claim 14 wherein said conveyor cartridge is insertable and removable into and from said toaster oven housing utilizing a spring clutch mechanism.

16. The toaster oven of claim 14 wherein said conveyor belt rotatable shafts are operatively associated with gears configured to operatively rotate said conveyer belt.

17. The toaster oven of claim 14 wherein said first and second doors are rotatably attached to said housing and allow users to open or close said first and second doors to a variety of degrees.

18. The toaster oven of claim 14 wherein said first and second doors are each composed of two layers of an insulating material constructed to maintain the temperature within said toaster oven.

19. The toaster oven of claim 14 wherein said toaster oven housing has a control panel allowing users to select their desired cooking options.

20. The toaster oven of claim 14 wherein said toaster oven housing has a control panel allowing users to choose the speed of rotation of the conveyor belt.

21. The toaster oven of claim 14 wherein the toaster oven is operated remotely by the use of an application on a smart device.

22. The toaster oven of claim 14 wherein the toaster is configured to follow instructions transmitted to it via guided cooking options displayed to users on a mobile app or preprogrammed within the toaster oven control panel.

23. The toaster oven of claim 14 wherein the control panel provides a touch screen interface for users to select their desired cooking options.

24. The toaster oven of claim 14 wherein the toaster oven is operable while said first and second doors are closed.

25. A toaster oven comprising:
a housing having an interior defining an oven cavity; rotatable shafts operatively associated with an electric drive motor driven by an electric source;
at least one continual conveyor belt loop trained over said rotatable shafts;
a conveyor belt cartridge to operatively associate with said rotatable shafts within said toaster oven;
a heating means for heating said oven cavity;
a first door providing the entry point of food products into the body of said toaster oven;
a second door providing the exit point of food products from within the body of said toaster oven; and
wherein said conveyor belt can be instructed to operate in rotate and static modes.

26. A toaster oven comprising:
A housing having an interior defining an oven cavity; said oven cavity having at least one opening;
rotatable shafts operatively associated with an electric drive motor driven by an electric source;
at least one conveyor belt trained over said rotatable shafts;
a conveyor cartridge operatively associated with said rotatable shafts within said toaster oven;
a heating means for heating said oven cavity; and
a front loading door pivotably attached to said housing and having the ability to open and close.
